(19) United States
(12) Patent Application Publication
(10) Pub. No.: US 2026/0171740 A1
(43) Pub. Date: Jun. 18, 2026

(54) QUICK CONNECTION DEVICE

(71) Applicant: Tida International Limited, Kowloon (HK)

(72) Inventor: Hongtao Liu, Kowloon (HK)

(21) Appl. No.: 19/018,114

(22) Filed: Jan. 13, 2025

(30) Foreign Application Priority Data
Dec. 17, 2024 (CN) 202411860832.0

(51) Int. Cl. H01R 33/97

(52) U.S. Cl. CPC H01R 33/973

(57) ABSTRACT

The present application relates to the technical field of connectors for installation of electrical appliances, in particular to a quick connection device. The quick connection device includes a plug for connection to an external electrical appliance and a socket for connection to an external power line, wherein the plug is detachably connected to the socket and used for electric connection to the socket, such that the external electrical appliance is fixed and conductive with the external power line; the plug comprises a shell, a grounding conductive column and a compression spring; one end of the compression spring is connected to the grounding conductive column, and the other end of the compression spring is connected to the shells; and after the plug is connected to the socket, the grounding conductive column is abutted against the socket, and the compression spring is compressed. Therefore, the electrical appliance can be installed fast.

### CROSS-REFERENCE TO RELATED APPLICATIONS

The present application claims the priority benefit of China application No. 202411860832.0 filed on Dec. 17, 2024. The entirety of China application No. 202411860832.0 is incorporated herein by reference and made a part of this specification.

### TECHNICAL FIELD

The present application relates to the technical field of connectors for installation of electrical appliances, in particular to a quick connection device.

### BACKGROUND ART

The installation of wall-mounted electrical appliances (such as fans, lamps, etc.) has always been a headache for a long time. When electrical appliances are installed, it is necessary to bear the weight of electrical appliances by hand and wire them at the same time, which increases the difficulty of installation and increases the dangerousness.

Therefore, how to achieve a lamp connector with reasonable structural design, fast connection, safety, reliability, easy disassembly and maintenance and high practicability is a technical problem to be solved urgently in the art.

### SUMMARY OF THE APPLICATION

The technical problem to be solved by the present application is to provide a quick connection device, which can be used to install electrical appliances such as lamps fast.

In order to solve the above technical problems, the present application adopts the following technical solution: a quick connection device includes a plug and a socket, the plug is detachably connected to the socket and used for electric connection to the socket; wherein the plug includes a shell, a grounding conductive column and a compression spring; one end of the compression spring is connected to the grounding conductive column, and the other end of the compression spring is connected to the shell ; and
after the plug is connected to the socket, the grounding conductive column is abutted against the socket, and the compression spring is compressed.

After the plug is connected to the socket, the grounding conductive column is abutted against the socket, such that the common grounding between the plug and the socket can be achieved fast without the need for an additional connection of ground wire between the plug and the socket. Meanwhile, the compression spring applies a force to the grounding conductive column to increase a pressure between the grounding conductive column and the socket, thereby reducing a contact resistance between the grounding conductive column and the socket.

Optionally, the shell is provided with a first cavity for accommodating the grounding conductive column; and the conductive column is configured to drive the grounding conductive column to extend out of the first cavity.

Optionally, the socket includes a hanging plate and a female terminal block; the female terminal block is installed on the hanging plate; after the connection between the plug and the socket, the grounding conductive column is abutted against the hanging plate, and the hanging plate is provided with a fixing hole.

The hanging plate and the female terminal block are combined to form the socket, and the hanging plate structure is easy to cooperate with other mounting parts and used for installing the female terminal block to a wall or ceiling.

Optionally, the hanging plate is provided with a docking hole, and a position of the female terminal block used for electric connection to the plug aligning with the docking hole.

Optionally, the female terminal block is provided with a second cavity and a conductive sheet partly located in the second cavity; the second cavity has a second opening and a third opening that communicate with the outside of the female terminal block; the second cavity is provided with a wrench, a pressing elastic sheet and a first shaft; the pressing elastic sheet is U-shaped and sleeved on the first shaft; a second shaft is arranged in the middle of the wrench; one end of the wrench extends from the second opening; and when the wrench rotates along the second shaft, the wrench pushes the pressing elastic sheet to rotate along the first shaft, such that one end of the pressing elastic sheet moves close to the conductive sheet, and a wire plugged from the third opening is pressed on the conductive sheet.

The wrench and other structural designs can facilitate an operator to connect the wire to the female terminal block, which is convenient and fast to operate.

Optionally, the female terminal block is provided with a third cavity and a first elastic member located in the third cavity; the third cavity has a fourth opening that communicates with the outside; a part of the conductive sheet is located in the third cavity; one end of the first elastic member is abutted against the conductive sheet; and the other end of the first elastic member is abutted against an inner wall of the third cavity, such that the conductive sheet is abutted against the plug plugged into the fourth opening.

The first elastic member may be a spring. The spring is abutted against the conductive sheet, such that the plug is docked with the socket. Then, the conductive sheet has a certain force against the conductive sheet of the male terminal block through the spring to enhance the conduction stability.

Optionally, the socket is provided with an elongated hole, the elongated hole has a first region and a second region along a length extension direction, and one side wall of the second region is provided with a locking groove; the plug is provided with a locking member, and the locking member can extend from and retract into a side surface of the plug; in a natural state, the locking member extends from the side surface of the plug; the locking member retracts toward the plug when subjected to a force facing the plug, and the locking member extends from the side surface of the plug again after the force disappears; and the first region allows at least part of the locking member to extend in; and when moving from the first region to the second region, the locking member retracts till it moves to be aligned with the locking groove and extends into the locking groove.

After the plug is electrically connected to the electrical appliance and the socket is electrically connected to the power line, the installation and power-on of the electrical appliance can be completed just by docking the plug with the socket, which is convenient and fast. Meanwhile, this solution also designs the locking member and the locking groove, such that the plug cannot become loose after being docked with the socket through the cooperation of the locking member and the locking groove, thereby effectively preventing the plug from being disengaged from the socket and the electrical appliance from falling off. During the assembly, the locking member needs only to be moved into the locking groove without adding additional installation steps, achieving easy installation. The disassembly can be performed by pressing the locking member by hand to make it escape from the locking groove, which is convenient and fast.

Optionally, in an orthographic projection of a horizontal plane of the elongated hole, the first region is wider than the second region; and when the locking member moves into the second region from the first region, the locking member retracts as constrained by the width of the second region.

Optionally, one end of the second region close to the first region is provided with an inclined plane, and the inclined plane is used for propping against the locking member; and

one end of the locking groove close to the first region is provided with a flat plane, and the flat plane is used for clamping with the locking member.

The inclined plane can prop against the locking member, such that the locking member automatically retracts as it moves to the second region from the first region. And the flat plane is used to be clamped with the locking member to limit the retraction of the locking member, so that the locking member cannot automatically exit after entering the locking groove, thereby limiting unlocking causing by the locking member entering the first region from the second region automatically.

Optionally, the plug is provided with a lifting lug; the first region allows the lifting lug to pass through; and when the locking member extends into the locking groove, an edge of the second region limits the lifting lug from passing through the elongated hole.

Optionally, the plug is provided with a lifting lug; the first region allows the lifting lug to pass through; and when the locking member extends into the locking groove, an edge of the second region limits the lifting lug from passing through the elongated hole.

The lifting lug is lapped on an upper edge of the second region to limit the plug from moving downward, such that the stability of connection between the plug and the socket can be well enhanced.

Optionally, the lifting lug is located above the locking member; and when the locking member extends into the locking groove, the top of the locking member and the lifting lug clamp the edge of the locking groove.

Optionally, a side wall of the locking member facing the locking groove is provided with a limiting groove; the limiting groove is L-shaped and located on the top of the locking member; and when the locking member extends into the locking groove, a bottom wall of the limiting groove and the lifting lug clamp the edge of the locking groove.

The design on the edge of the occlusion locking groove formed by the match of the lifting lug and the limiting groove can limit the plug from moving upward and downward, thereby further ensuring the stability of the plug after being docked with the socket. It should be noted that the meaning of occlusion is not to completely occlude the edge of the locking groove, but also to allow certain space to float up and down, which is convenient for installation and alignment.

Optionally, the plug includes a bracket and a male terminal block; the bracket includes a base and a vertical portion connected to the base; the lifting lug is arranged on the vertical portion and extends toward an extension direction of the locking member; the vertical portion is provided with a telescopic hole located below the lifting lug; the locking member is arranged on the male terminal block; the male terminal block is installed on the base; and the telescopic hole is used for the locking member to pass through.

The vertical portion of the bracket is designed so that the lifting lug and the locking member are located on the same vertical line. The lifting lug plays a certain role in protecting the locking member to prevent the locking member from accidentally colliding with the locking member during the docking process of the plug and the socket, causing the locking member to be damaged without normal extension and contraction, resulting in the failure of the locking function.

Optionally, the male terminal block is provided with a third cavity and a second elastic member located in the third cavity; the third cavity has a first opening that communicates with the outside; the locking member extends from the first opening; one end of the second elastic member is abutted against the locking member; the other end of the second elastic member is abutted against a bottom wall of the third cavity; a stroke groove is formed in both sides of the third cavity, respectively; and a part of the locking member that is located in the third cavity is provided with convex portions corresponding to the stroke grooves.

The cooperation of the stroke grooves and the convex portions of the locking member limits a distance of the locking member moving forward and backward, thereby preventing the locking member from completely escaping from the male terminal block. The second elastic member may be a spring through which the extension and retraction of the locking member can be achieved.

Optionally, the elongated hole is in an arc shape; and when the plug is docked with the socket, the locking member is allowed to slide into the second region from the first region and extend into the locking groove by rotating the plug.

The elongated hole is designed into an arc shape, and the plug can be rotated to complete the extension of the locking member into the locking groove after being docked with the socket, achieving simple operation steps and low installation difficulty.

Optionally, the socket is provided with a circular jack; the plug is provided with a circular plugging portion corresponding to the circular jack; and the plug can rotate relative to the socket after being abutted.

The design of the circular jack and the circular plugging portion is adopted, and the locked installation can be completed by plugging and rotation when they are docked.

### BRIEF DESCRIPTION OF THE DRAWINGS

FIG. 1 is a schematic structural diagram when a plug is not docked with a socket in the present application.

FIG. 2 is a schematic exploded view of a three-dimensional structure of a female terminal block and a hanging plate in the present application.

FIG. 3 is a schematic exploded view of a three-dimensional structure of the female terminal block in the present application.

FIG. 4 is a schematic structural diagram of a front surface of the hanging plate in the present application.

FIG. 5 is a schematic exploded view of a three-dimensional structure of a male terminal block and a bracket in the present application.

FIG. 6 is a schematic exploded view of a three-dimensional structure of the male terminal block in the present application.

FIG. 7 is a schematic sectional view of a side structure after the plug is docked with the socket in the present application.

FIG. 8 is a schematic diagram of a three-dimensional structure after the plug is docked with the socket in the present application.

FIG. 9 is a schematic sectional view of a side structure after the female terminal block is provided with a wrench in the present application.

FIG. 10 is a schematic sectional view of a side structure after the female terminal block is provided with the wrench and a wire is plugged in the present application.

### DETAILED DESCRIPTION OF THE INVENTION

In order for the understanding of a person skilled in the art, the present application will be further described below in conjunction with the embodiments, and the content mentioned in the implementations is not intended to limit the present application.

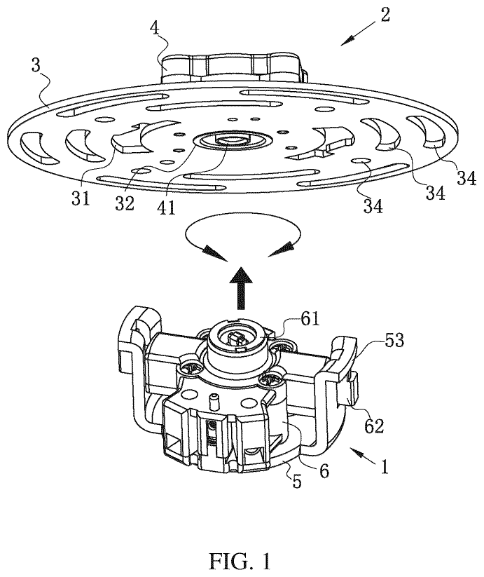

As shown in FIG. 1, a quick connection device includes a plug 1 for connection to an external electrical appliance and a socket 2 for connection to an external power line, wherein the plug 1 is detachably connected to the socket 2 and used for electric connection to the socket 2, such that the external electrical appliance is fixed and conductive with the external power line.

The socket 2 includes a hanging plate 3 and a female terminal block 4 fixed on the hanging plate 3 through a screw. The hanging plate 3 is provided with an arc-shaped elongated hole 31, and other fixing holes 34. The socket 2 is fixed on a wall or ceiling through the other fixing holes 34. The plug 1 includes a bracket 5 and a male terminal block 6 fixed on the bracket 5 through a screw. The bracket 5 is designed to match a position for connection with the electrical appliance, and then the plug 1 is fixed on the electrical appliance. During installation, the plug 1 on the electrical appliance is aligned with and plugged into the socket 2 on the wall or ceiling, and the electrical appliance is rotated at a certain angle, so that the plug 1 rotates at certain angle relative to the socket 2 to complete the installation. The hanging plate 3 is made of a conductive material.

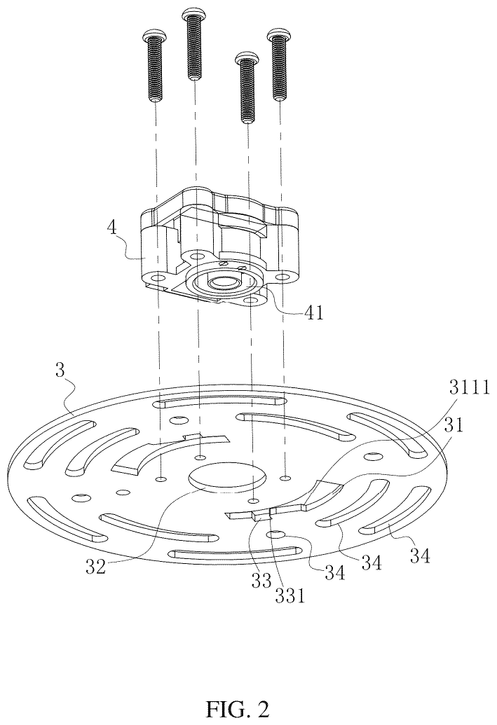

As shown in FIGS. 2 to 4, the female terminal block 4 is fixed on the hanging plate 3 through a screw, the hanging plate 3 is a circular plate with certain thickness, and the hanging plate 3 has a docking hole 32. After the female terminal block 4 is fixed on the hanging plate 3, a circular jack 41 of the female terminal block 4 is aligned with the docking hole 32. When the plug 1 is docked with the socket 2, a circular plugging portion 61 of the plug 1 is plugged into the circular jack 41 through the docking hole 32, and then the conductive sheet 11 of the plug 1 is in contact and conductive with the conductive sheet 21 of the socket 2. The hanging plate 3 is further provided with two arc-shaped elongated holes 31, which are located on both opposite sides of the docking hole 32. Each arc-shaped elongated hole 31 has a first region 311 and a second region 312. In an orthographic projection of a horizontal plane of the elongated hole 31, the first region 311 is wider than the second region 312, and the so-called width refers to a width between two long sides of the arc-shaped elongated hole 31. A hole wall of the second region 312 is provided with a locking groove 33. Specifically, the locking groove 33 is located on a side edge of the second region 312.

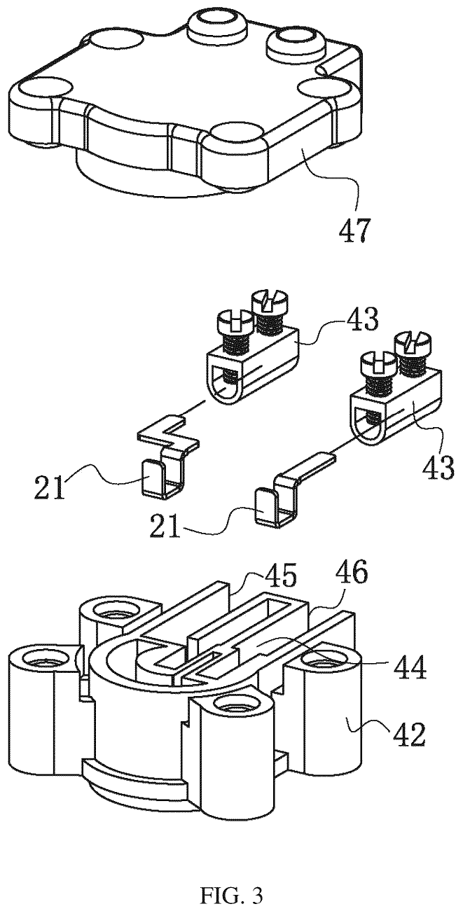

As shown in FIG. 3, the female terminal block 4 includes a shell 42. The shell 42 is provided with a cavity 44 for accommodating two conductive wire lockers 43. A conductive sheet 21 is fixed on each conductive wire locker 43. The shell 42 has three openings which communicate with the cavity 44, wherein two openings 45 and 46 correspond to the conductive wire lockers 43, and the remaining opening is located on a bottom surface of the shell 42 and designed as the circular jack 41. One end of the conductive sheet 21 is fixed by the conductive wire locker 43 and used for being in contact and conductive with the plugged wire, and the other end of the conductive sheet 21 extends to the circular jack 41 and is exposed. The shell 42 is also connected to a sealing cover 47 for covering the cavity 44. The shell 42 is made of a non-conductive material.

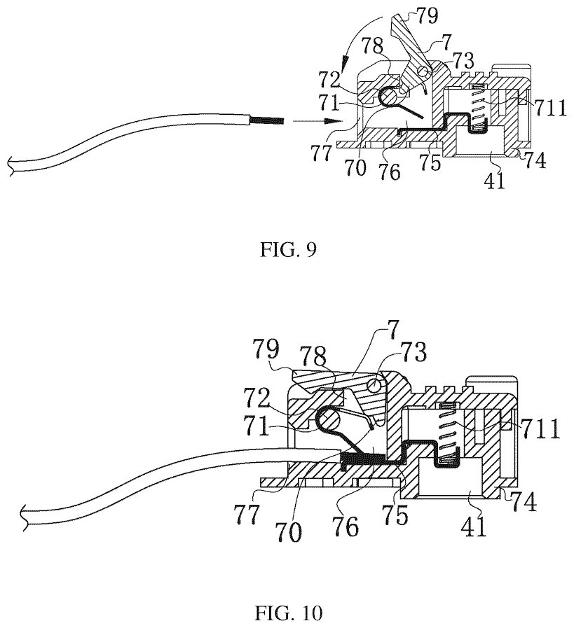

As shown in FIG. 9 to FIG. 10, in other embodiments, the female terminal block 4 does not adopt a design of conductive wire lockers 43, but instead achieves the compression of the plugged wire by designing structures such as a wrench 7, thereby ensuring the conduction stability between the conductive sheet 75 and the wire. Specifically, the shell 74 of the female terminal block 4 is provided with a cavity 76 for the conductive sheet 75 to be installed. The shell 74 is provided with two openings 77 which communicate with the cavity 76 and allow wires to be plugged, two openings 78 for the wrench 7 to be partially exposed, and a circular jack 41 located on a bottom surface of the shell. One end of the conductive sheet 75 is exposed from the circular jack 41, and the other end of the conductive sheet 75 is exposed from the opening 77 for the power line to be plugged. The wrench 7, a pressing elastic sheet 71 and a first shaft 72 are arranged in the cavity 76. The pressing elastic sheet 71 is U-shaped and socketed on the first shaft 72. The wrench 7 is L-shaped and has a second shaft 73 in the middle. One end of the wrench 7 extends from the corresponding opening 78. An end 79 is exposed from the opening 78 by pressing the wrench 7 by hand. The wrench 7 rotates along the second shaft 73. An inner end 70 of the wrench 7 pushes the pressing elastic sheet 71 to rotate along the first shaft 72, such that one end of the pressing elastic sheet 71 moves close to the conductive sheet 75, and the wire extending from the opening 77 is pressed on the conductive sheet 75, thereby effectively ensuring the conduction stability.

As shown in FIG. 9 to FIG. 10, in other embodiments, the female terminal block 4 may be additionally provided with a spring 711 between the conductive sheet 75 and an inner wall of the cavity 76. The spring 711 provides a force facing the conductive sheet 75 towards the circular jack 41, so that the conductive sheet 75 can be in better contact and conductive with the conductive sheet 11 on the plug 1.

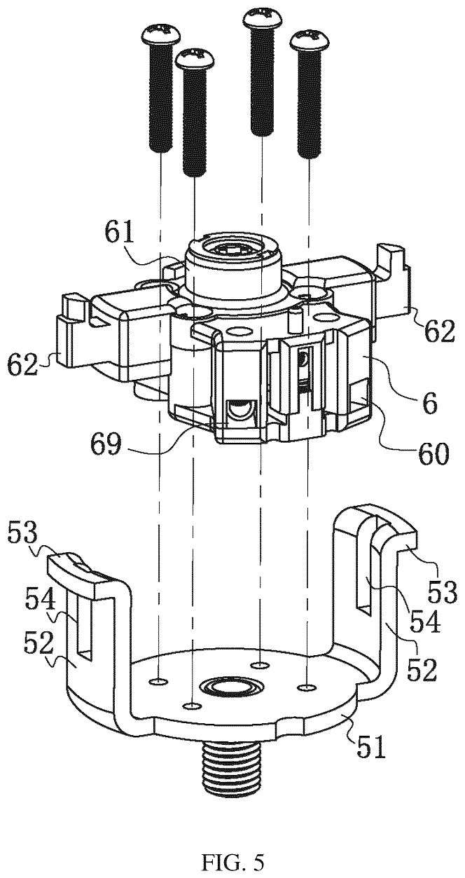

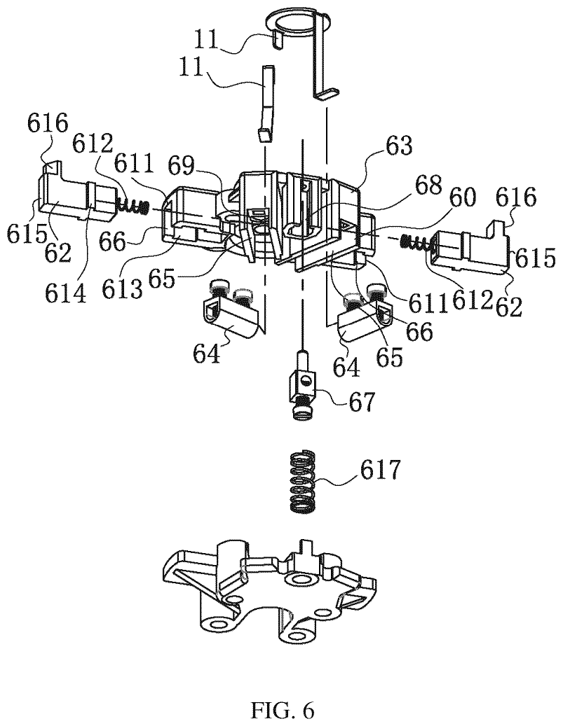

As shown in FIG. 5 to FIG. 6, the female terminal block 4 is fixed on the bracket 5 through a screw. The bracket 5 is composed of a base 51 and a vertical portion 52 extending from the base 51. There are two vertical portions 52 that are respectively located on both opposite sides of the base 51. A free end of each vertical portion 52 has a lifting lug 53, and the lifting lug 53 extends in an extension direction of the locking member 62. The vertical portion 52 is further provided with a telescopic hole 54 which is located below the lifting lug 53. The locking member 62 is installed on the male terminal block 6. The male terminal block 6 is arranged on the base 51, and the locking member 62 is aligned with the telescopic hole 54 of the vertical portion 52. The locking member 62 is extended and retracted by passing through the telescopic hole 54.

As shown in FIG. 6, the male terminal block 6 includes a shell 63. The shell 63 is provided with two cavities 65 for accommodating two conductive wire lockers 64, two cavities 66 for respectively accommodating two locking members 62, and a cavity 68 for accommodating the grounding conductive column 67. The male terminal block further includes a compression spring 617. The compression spring 617 may be located inside the cavity 68. One end of the compression spring 617 is connected to the grounding conductive column 67, and the other end of the compression spring 617 is connected to the shell 63 to drive the grounding conductive column 67 to extend out of the cavity 68. After the male terminal block 6 is connected to the female terminal block 4, the grounding conductive column 67 props against the hanging plate 3, the hanging plate 3 compels the grounding conductive column 67 to retract into the cavity 68, and the compression spring 617 is compressed. The compression spring 617 applies a force to the grounding conductive column 67 to increase a pressure between the grounding conductive column 67 and the hanging plate 3, thereby reducing a contact resistance between the grounding conductive column 67 and the hanging plate 3. The grounding conductive column 67 can be electrically connected to a ground wire of the external electrical appliance. Specifically, the grounding conductive column 67 can be electrically connected to a ground wire of the external electrical appliance directly, or may also be connected to the ground wire of the external electrical appliance through the compression spring 617. The shell 63 is also provided with three openings that communicate with the cavities 65 of the conductive wire lockers 64, wherein the two openings 69 and 60 correspond to two cavities 65 for accommodating the conductive wire lockers 64 and allow wires to be plugged for docking with the conductive sheets 11 on the conductive wire lockers 64, and the remaining one opening is located at the circular plugging portion 61 on the top surface of the shell. The conductive sheet 11 fixed by the conductive wire locker 64 extends to the circular plugging portion 61 and is exposed from the opening, so that when the circular plugging portion 61 is docked with the circular jack 41, the conductive sheet 11 of the circular plugging portion 61 is in contact and conductive with the conductive sheet 21 of the circular jack 41.

As shown in FIG. 6, the shell 63 is further provided with two cavities 66 that correspond to two locking members 62, respectively. Each cavity 66 has an opening 611. A spring 612 is arranged in the cavity 66. One end of the spring 612 is abutted against the locking member 62, and the other end of the spring 612 is abutted against a bottom wall of the cavity 66, such that the locking member 62 can extend and contract along the opening 611. A stroke groove 613 is formed in both sides of the cavity 66, and a part of the locking member 62 in the cavity 66 is provided with convex portions 614 that correspond to the stroke grooves 613. When the locking member 62 moves reciprocatingly along the opening 611 of the cavity 66, the locking member 62 is prevented from completely escaping from the opening 611 through the cooperation of the convex portions 614 and the stroke grooves 613.

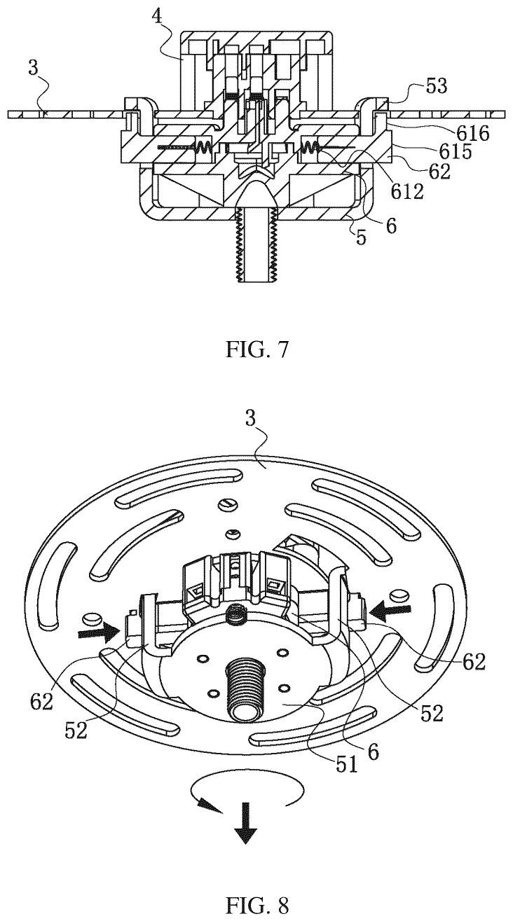

As shown in FIGS. 5 to 7, a side wall 615 of the locking member 62 facing a locking groove 33 is provided with a limiting groove 616, and the limiting groove 616 is located on the top of the locking member 62 and is in an L shape that extends into the top surface of the locking member 62. When the locking member 62 enters the locking groove 33, a bottom surface of the limiting groove 616 can prop against a lower edge of the locking groove 33; and meanwhile, the lifting lug 53 is lapped at an upper edge of the locking groove 33, that is, a bottom wall of the limiting groove 616 and the lifting lug 53 jointly clamp the edge of the locking groove 33. The lifting lug 53 and the limiting groove 616 of the locking member 62 occlude the edge of the locking groove 33 to effectively limit the plug 1 from moving upward and downward. The simple structure enhances the stability of the plug 1 and the socket 2 after docking. It should be noted that the occlusion is not to completely occlude the edge of the locking groove 33, but also to allow certain space to float up and down, which is convenient for installation and alignment.

As shown in FIG. 1 and FIG. 8, in the docked installation process of the plug 1 and the socket 2, the female terminal block 4 is fixed on the hanging plate 3 through a screw. The hanging plate 3 is fixed to the wall or ceiling through its other fixing holes 34 in conjunction with screws and other parts to achieve fixation and grounding. The male terminal block 6 is fixed on the bracket 5 through a screw, and the bracket 5 is fixed to the electrical appliance through a screw or other parts. The male terminal block 6 on the electrical appliance is aligned with and plugged in the female terminal block 4 on the wall or ceiling. At this time, the circular plugging portion 61 of the male terminal block 6 is plugged into the circular jack 41 of the female terminal block 4, the vertical portion 52 of the bracket 5 extends into the first region 311 of the arc-shaped elongated hole 31 of the hanging plate 3, and the vertical portion 52 extends into the first region 311. The lifting lug 53 that makes way to a free end of the vertical portion 52 passes through the first region 311 and is located above the hanging plate 3. The telescopic hole 54 of the vertical portion 52 is at least partially aligned with a hole wall of the first region 311, and the limiting groove 616 of the locking member 62 is then aligned with the hole wall of the first region 311. After the plugging is completed, the electrical appliance is rotated, such that the male terminal block 6 rotates relative to the female terminal block 4. The locking member 62 and the lifting lug 53 move into the second region 312 as the male terminal block 6 rotates. The locking member 62 is aligned with and extends into the locking groove 33. The lifting lug 53 is lapped on the second region 312, i.e., the upper edge of the locking groove 33, thereby completing locked and fixed installation. During disassembly, two locking members 62 need to be manually pressed, and the locking member 62 does not escape from the locking groove 33 and rotate in reverse, so that the locking member 62 and the lifting lug 53 enter the first region 311 from the second region 312. The locking member 62 and the lifting lug 53 are pulled in a direction perpendicular to a rotation direction, such that the locking member 62 and the lifting lug 53 exit from the first region 311, and the plug 1 is disengaged from the socket 2.

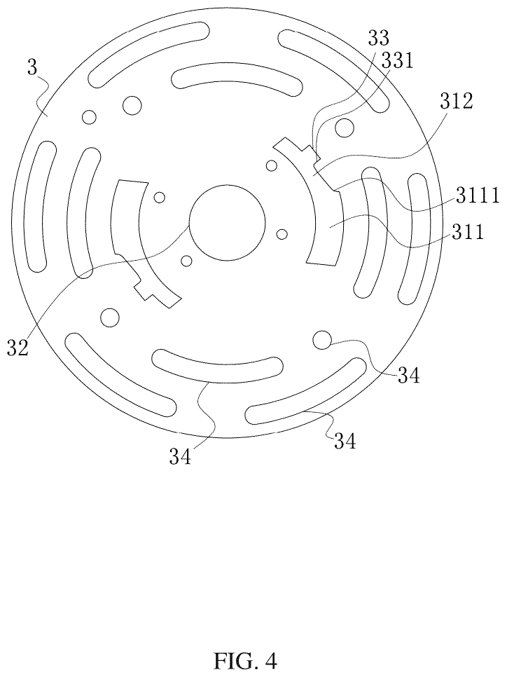

In the first region 311 and the second region 312 of the hanging plate 3, the wider first region 311 can allow the locking member 62 on the plug 1 and the lifting lug 53 to pass through, and the narrower second region 312 causes the locking member 62 to retract until it is aligned with the locking groove 33 and then extend out again, thereby playing a locking effect. At the same time, the narrower second region 312 can clamp the vertical portion 52 on the bracket 5 to a certain extent, and also make the lifting lug 53 have a lap position, thereby greatly enhancing the connection stability after the plug 1 is abutted against the socket 2. Specifically, as shown in FIG. 2 and FIG. 4, one end of the second region 312 close to the first region 311 has an inclined plane 3111, and the inclined plane 3111 is used to prop against the locking member 62, such that the locking member 62 automatically retracts during the process of moving from the first region 311 to the second region 312. One end of the locking groove 33 close to the first region 311 has a flat plane 331. The flat plane 331 is used to be clamped with the locking member 62 to limit the retraction of the locking member 62, so that the locking member 62 cannot automatically exit after entering the locking groove 33, thereby limiting the locking member 62 from entering the first region 311 from the second region 312 automatically.

The above-mentioned embodiments only express several implementations of the present application, and the description is relatively specific and detailed, but it should not be understood as a limitation to the patent scope of the present application. It should be pointed out that for those of ordinary skill in the art, without departing from the concept of the present application, several modifications and improvements can be made, and these all fall within the protection scope of the present application. Therefore, the protection scope of the patent of the present application should be subject to the appended claims.

1. A quick connection device, comprising a plug and a socket, wherein the plug is detachably connected to the socket and used for electric connection with the socket;
the plug comprises a shell, a grounding conductive column and a compression spring; one end of the compression spring is connected to the grounding conductive column, and a second end of the compression spring is connected to the shell; and
after the plug is connected to the socket, the grounding conductive column is abutted against the socket, and the compression spring is compressed.

2. The quick connection device according to claim 1, wherein the shell is provided with a first cavity for accommodating the grounding conductive column; and the compression spring is configured to drive the grounding conductive column to extend out of the first cavity.

3. The quick connection device according to claim 1, wherein the socket comprises a hanging plate and a female terminal block, the female terminal block is disposed on the hanging plate, after a connection between the plug and the socket, the grounding conductive column is abutted against the hanging plate, and the hanging plate is provided with a fixing hole.

4. The quick connection device according to claim 3, wherein the hanging plate is provided with a docking hole, and a position of the female terminal block used for electric connection to the plug aligns with the docking hole.

5. The quick connection device according to claim 3, wherein the female terminal block is provided with a second cavity and a conductive sheet partly located in the second cavity; the second cavity has a second opening and a third opening that communicate with an outside of the female terminal block; the second cavity is provided with a wrench, a pressing elastic sheet and a first shaft; the pressing elastic sheet is sleeved on the first shaft; a second shaft is arranged in a middle of the wrench; one end of the wrench extends from the second opening; and when the wrench rotates along the second shaft, the wrench pushes the pressing elastic sheet to rotate along the first shaft, such that one end of the pressing elastic sheet moves toward the conductive sheet.

6. The quick connection device according to claim 5, wherein the pressing elastic sheet is U-shaped.

7. The quick connection device according to claim 5, wherein the wrench is L-shaped.

8. The quick connection device according to claim 3, wherein the female terminal block is provided with a third cavity and a second elastic member located in the third cavity; the third cavity has a fourth opening that communicates with an outside; a part of a conductive sheet is located in the third cavity; one end of the second elastic member is abutted against the conductive sheet; and a second end of the second elastic member is abutted against an inner wall of the third cavity, such that the conductive sheet is abutted against the plug plugged into the fourth opening.

9. The quick connection device according to claim 1, the socket is provided with an elongated hole, the elongated hole has a first region and a second region along a length extension direction, and one side wall of the second region is provided with a locking groove;
the plug is provided with a locking member, and the locking member is configured to extend from and retract into a side surface of the plug; in a natural state, the locking member extends from the side surface of the plug; the locking member retracts toward the plug when subjected to a force facing the plug, and the locking member extends from the side surface of the plug after the force disappears; and
the first region allows at least part of the locking member to extend into the first region; and when moving from the first region to the second region, the locking member retracts until the locking member moves to be aligned with the locking groove and extends into the locking groove.

10. The quick connection device according to claim 9, wherein in an orthographic projection of a horizontal plane of the elongated hole, the first region is wider than the second region; and when the locking member moves into the second region from the first region, the locking member retracts as constrained by a width of the second region.

11. The quick connection device according to claim 10, wherein one end of the second region close to the first region is provided with an inclined plane, and the inclined plane is used for propping against the locking member; and
one end of the locking groove close to the first region is provided with a flat plane, and the flat plane is used for clamping with the locking member.

12. The quick connection device according to claim 9, wherein the plug is provided with a lifting lug; the first region allows the lifting lug to pass through; and when the locking member extends into the locking groove, an edge of the second region limits the lifting lug from passing through the elongated hole.

13. The quick connection device according to claim 12, wherein the lifting lug is located above the locking member; and when the locking member extends into the locking groove, a top of the locking member and the lifting lug clamp an edge of the locking groove.

14. The quick connection device according to claim 12, wherein a side wall of the locking member facing the locking groove is provided with a limiting groove; the limiting groove is L-shaped and located on a top of the locking member; and when the locking member extends into the locking groove, a bottom wall of the limiting groove and the lifting lug clamp an edge of the locking groove.

15. The quick connection device according to claim 12, wherein the plug comprises a bracket and a male terminal block; the bracket comprises a base and a vertical portion connected to the base; and
the lifting lug is arranged on the vertical portion and extends toward an extension direction of the locking member.

16. The quick connection device according to claim 15, wherein the vertical portion is provided with a telescopic hole located below the lifting lug; the locking member is arranged on the male terminal block; the male terminal block is disposed on the base; and the telescopic hole is used for the locking member to pass through.

17. The quick connection device according to claim 15, wherein the male terminal block is provided with a third cavity and a second elastic member located in the third cavity; the third cavity has a first opening that communicates with an outside of the male terminal block; the locking member extends from the first opening; one end of the second elastic member is abutted against the locking member;
and a second end of the second elastic member is abutted against a bottom wall of the third cavity.

18. The quick connection device according to claim 17, wherein a stroke groove is formed in both sides of the third cavity, respectively; and a part of the locking member that is located in the third cavity is provided with convex portions corresponding to the stroke grooves.

19. The quick connection device according to claim 9, wherein the elongated hole is in an arc shape;
and when the plug is docked with the socket, the locking member is allowed to slide into the second region from the first region and extend into the locking groove by rotating the plug.

20. The quick connection device according to claim 1, wherein the socket is provided with a circular jack; the plug is provided with a circular plugging portion corresponding to the circular jack; and the plug is configured to rotate relative to the socket after being abutted.
